(19) United States
(12) Patent Application Publication
(10) Pub. No.: US 2006/0108714 A1
(43) Pub. Date: May 25, 2006

(54) Method for surface treatment of a substrate

(75) Inventors: Lars Pedersen, Hjoerring (DK); Thomas Munch-Laursen, Kolding (DK); Oria Lang Soerensen, Baelum (DK); Peter Astrup Simmelsgaard, Tommerup (DK)

Correspondence Address: BANNER & WITCOFF, 1001 G STREET N W, SUITE 1100, WASHINGTON, DC, 20001, US

(73) Assignee: BUILDMATE A/S, Hobro (DK)

(21) Appl. No.: 10/523,074

(22) PCT Filed: Jul. 10, 2003
(86) PCT No.: PCT/EP03/07479

§ 371 Date: Nov. 23, 2005

(30) Foreign Application Priority Data
Jul. 30, 2002 (GB) 0217543.8

(51) Int. Cl. B06B 1/02; B29C 39/12

(52) U.S. Cl. 264/443; 264/69; 264/316; 264/259; 264/35; 264/102; 264/148; 264/151

(57) ABSTRACT

A method for the surface treatment of a substrate, for example concrete roof tiles, comprising spreading a layer of water-containing hardenable paste containing binder and other particles, for example a cement based slurry, covering the paste layer with (a) a flexible membrane or (b) a plate or (c) first a flexible membrane then superimposed thereon a plate, the plate or membrane having an upper-surface and a smooth under-surface, optionally vibrating the membrane-covered or plate-covered area of the paste layer, such that vibration is transmitted through the membrane or plate, to the paste layer, and either removing the membrane, plate or plate and membrane then hardening the paste layer on the substrate, or at least partially hardening the paste layer on the substrate with the membrane, plate or plate and membrane in place.

This invention relates to a method for the surface treatment of substrates such as walls, floors, columns, and of clay, ceramic or cementitious articles, particularly roofing, floor and wall tiles, roofing panels and wall cladding panels, work tops and paving blocks. The method increases the smoothness, and can increase the density and hardness, of surfaces of such substrates and articles, thereby producing a glaze effect and, in the case of substrates and articles exposed to weathering, increasing resistance to water penetration and to mould, moss, lichen or algae growth.

### BACKGROUND OF THE INVENTION

Walls, floors, tiles, ceilings, columns and other building elements are often constructed from materials such as brick and concrete, which present a rough surface finish. In many cases, it is desirable to treat such surfaces to render them smooth. This has commonly been achieved by spreading a viscous secondary layer, for example of plaster or cement-based mortar, on the rough surface, and smoothing the secondary layer with a smoothing tool before allowing it to cure.

Tiles for flooring, roofing or wall cladding are commonly made from clay or concrete, but can also be made from cement paste with a high loading of fibres. The latter are often formed as panels, larger in area than normal roofing tiles of clay or concrete.

Concrete tiles are produced in an extrusion process, wherein an extrudable, concrete mass is extruded as a ribbon and is passed through elements of the manufacturing apparatus which press, mould and cut the sheet into individual roofing tile format. Clay tiles are usually produced in a pressing process, the clay mass being pressed into moulds to form and shape the tiles. After extrusion or pressing, the tiles are then hardened, usually by accelerated curing methods involving heat.

The surfaces of conventionally produced tiles tend to be somewhat rough, porous, and susceptible to scratching, especially in the case of concrete tiles. Surface porosity is undesirable because it affects the surface smoothness and results in water penetration, which carries an increased risk of degradation of the tile in freeze-thaw conditions, and makes the surface susceptible to moss, mould, lichen and algae growth, which is unsightly, and in the case of moss can lead to degradation of the tile. The surfaces of the tile are vulnerable to these adverse effects of water deposited on the weather exposed surface through rainfall, humidity, fog and the like, and on the interior facing surfaces through condensation. To reduce the roughness and porosity and to improve the appearance of the tiles they are often glazed by either applying silicate frits to the surface and firing at high temperature or by painting with a hardenable lacquer prior to curing. Reduced roughness and porosity are also desirable objectives for tiles and other surfaces used indoors, for aesthetic and/or cleaning purposes.

It would therefore be desirable to improve tile processing to reduce surface roughness and porosity, and to impart a glazed appearance to the tiles without the necessity and additional expense of a separate lacquering step. Other articles of clay, and concrete, for example pipes, guttering, ornamental panelling, kitchen worktops, paving blocks and the like would also benefit from such processing improvement. Ceramic articles too, such as wall and floor tiles could also benefit.

### BRIEF DESCRIPTION OF THE INVENTION

The present invention makes available a method for improving surface smoothness, and in many cases the surface density and hardness, of substrates such as walls, floors, ceilings columns and sections thereof, and of clay, ceramic and cementitious articles, by applying a paste layer to the surface of the substrate or hardened or unhardened article, covering the paste layer with a smooth membrane or plate, and optionally vibrating the paste layer through the membrane or plate. The membrane or plate is separated from the paste layer prior to or after partial or substantially complete hardening. The optional surface vibration step has the effect of modifying the packing characteristics of the particles at the surface of the paste layer, increasing the density, and homogeneity of particles in the paste layer, to a depth which varies according to the composition of the paste, and the frequency, amplitude and duration of the vibration.

### DETAILED DESCRIPTION OF THE INVENTION

According to the invention, there is provided a method for the surface treatment of a substrate, which method comprises

(i) spreading a layer of hardenable paste over a surface area of the substrate to be treated, the paste comprising at least first and second populations of particles co-dispersed in a water-containing phase, the second population being sufficiently small to pack the interstices between particles of the first population with which it is co-dispersed, at least one of the first and second populations being of reactive binder particles,

(ii) covering a surface area of the paste layer with (a) a flexible membrane or (b) a plate or (c) first a flexible membrane then superimposed thereon a plate, the plate or membrane having an upper-surface and a smooth under-surface, such that in cases (a) and (c) the smooth membrane under-surface, and in case (b) the smooth plate under-surface, is in intimate contact with and conforms to the contours of that surface area of the paste layer, thereby providing a membrane-covered or plate-covered area of the paste layer,

(iii) optionally vibrating the membrane-covered or plate-covered area of the paste layer, such that vibration is transmitted through the membrane or plate, to the paste layer, and

(iv) either removing the membrane, plate, or plate and membrane then hardening the paste layer on the substrate, or at least partially hardening the paste layer on the substrate with the membrane, plate or plate and membrane in place.

The Substrate, Article or Mass to be Surface Treated

In one aspect of the invention, the substrate to be treated is a preformed wall, floor, ceiling, or column.

In another aspect, the method of the invention is applied to a hardened or partially hardened clay, ceramic or cementitious article, or to hardenable, water-containing clay, ceramic or cementitious mass shaped in the form of the desired article. The article may be pressed or otherwise moulded from clay or ceramics material, or formed from a cementitious mass such as concrete or fibre-loaded cement paste by extrusion, rolling, pressing or a combination of such techniques. The water content of the mass to be treated by the method of the invention is not critical, but is preferably as low as possible, consistent with the shaping and handling requirements of the particular article. Clay and cementitious articles are hardenable at ambient or elevated temperatures, or by microwave irradiation. Ceramic articles are hardenable by firing at high temperatures. Articles to which the invention is particularly applicable include, floor, wall and roofing tiles, as well as roofing and wall cladding panels, work-tops, paving blocks, and drainage pipes.

In the case of concrete tiles, especially roofing tiles, the shaped mass to which the method of the invention is applied will normally be provided by the precuring production stages of a conventional tile production process. In such processes, a mouldable, hardenable mass comprising at least water and reactive binder particles, the latter including at least cement particles, is extruded from an extrusion orifice onto conveyor means adapted to carry the extruded mass as a ribbon away from the extrusion orifice. The ribbon has a lower surface in contact with the conveyor means and an upper surface, and is passed under a compacting and smoothing plate (known as a “slipper” or “glitter”), the lower surface of which contacts the upper surface of the ribbon across its width as it is conveyed under the plate by the conveyor means. The plate is positioned such that the extruded ribbon is pinched between the lower plate surface and the conveyor means as it passes under the plate, thereby compacting the ribbon and smoothing its upper surface as it slides in contact with the lower plate surface. The pressed, smoothed ribbon is then cut across its width into individual tiles. Usually, the conveyor means is a conveyor belt provided with a plurality of longitudinally closely adjacent pallets or moulds of individual tile dimensions onto which the ribbon is extruded, and the ribbon is cut into individual tiles across its width between adjacent pallets of moulds.

As is described in more detail below, the paste layer may be applied as step (i) of the invention to the extruded tile ribbon or to the individual tiles cut from the ribbon

The method of the invention is in principle independent of the composition of the substrate to which the paste is applied. For example, it can be applied to conventional concrete tile mixes, based on cement particles, sand and water. However, the composition may also include reactive silica, such as ground granulated blast furnace slag, or pozzolanic ingredients like fly ash, calcined kaolin or fumed silica, whose incorporation into the mix may be aided by a surfactant or plasticiser. Fibres of steel, glass or plastics material such as polyethylene may also be included. The particle sizes of the cement, sand and fumed silica (microsilica) may be selected for dense packing, for example where the sand has a volume average particle size in the range 0.1 mm to 10 mm (or where two or more grades of sand are used, each grade has a volume average particle size in that range) and the microsilica powder has a volume average particle size in the range 0.001 μm to 100 μm, (or where two or more grades of microsilica are used, each grade has a volume average particle size in that range). Fibres of length 3 mm to 100 mm are useful for increasing toughness.

The Paste

As used herein the term “paste” means a spreadable composition which has sufficient viscosity to remain in place on the substrate when orientated for treatment in accordance with the invention, for the duration of the method of the invention after being spread thereon as a layer, without to any significant extent flowing off or pooling on the surface of the article. Pastes therefore may have the consistency of a thick lacquer, slurry, grout, mortar, or dough. Paste having suitable rheological properties for use in the invention will often meet the following slump test requirement:
On a horizontal glass plate place a ring having an inner diameter of 5 cm and a height of 5 cm. Fill the ring with paste and remove the ring. The paste slumps, and spreads on the plate. Measure or estimate the average distance from the point corresponding to the center of the ring (now removed) to the edge of the spread paste. That distance should be in the range 4 cm to 15 cm.

The method of spreading the paste as a layer on the substrate will depend on its consistency and workability, and the orientation of the substrate for treatment. In many cases, it will be possible to spray the paste on the substrate to the required layer thickness, or deposit the layer by passing the substrate or article through a falling curtain of paste, or passing a falling curtail of paste over the substrate. In other cases, it will be spreadable by means of a spreading tool, as a mortar layer is applied with a trowel. In other cases, the paste may be spread by pressure applied to individual portion(s) of paste deposited on the substrate, for example by pressing the flexible membrane or plate onto the paste portions by means of a roller, thereby squeezing paste as a layer between the membrane or plate and the substrate. In yet other cases, paste carried on a rotating roller may be spattered from the roller onto the substrate by a brush which rotates in contact with the roller-carried paste layer.

The thickness of the paste layer on the substrate is not critical and may vary according to the size of the substrate, the composition of the paste, and the wear characteristics desired in the finished product. In general, the layer will be from 0.1 mm to 3 mm.

The eventually hardenable paste comprises at least first and second populations of particles co-dispersed in a water-containing phase, the second population being sufficiently small to pack the interstices between particles of the first population with which it is co-dispersed. The first population may have a weight average particle size in the range 1 μm to 500 μm and the second population may have number average particle size from 0.001 μm to 0 μm.

At least one of the first and second particle populations must be of reactive binder particles, i.e. particles which bind to one another during the paste hardening process, for example cement, chalk, fly ash, microsilica or blastfurnace slag particles which bind via hydration products. However, other particle-binding mechanisms exist, for example covalent cross-linking of polymer particles, and such binder particles and mechanisms may be used for specialized applications of the method of the invention.

In many cases, the first particle population will be of binder particles, and the second of binder or non-binder particles. In these cases, the first particle population may be of cement, fly ash, or blastfurnace slag particles, with cement being preferred, and the second population may be of microsilica binder particles or non-binder particles such as iron oxide. However, the case where the first population is of non-binder particles such as micro-aggregate sand particles, and the second is of binder particles such as microfine cement or blast furnace slag is also useable in the method of the invention.

The second particle population packs the interstices between particles of the first particle population. Because of such packing, the surface of the hardened paste has the potential for low porosity, smoothness, and high density. The use of a flexible membrane or plate, and optional vibrational treatment, in accordance with the invention encourages the development of those features. To further maximize the potential smoothness of the paste surface layer, it is desirable that the paste should be mixed under conditions which minimize entrained air bubbles, or that the paste should be degassed, prior to spreading on the article.

A simple paste recipe for use in the method of the invention might be:
about 48% by weight of cement; with a mean particle size in the range 10-20 μm
about 33% by weight of fine sand with a mean particle size in the range 100-150 μm
about 19% by weight of water; and
small amount of plasticiser to aid dispersion.

The paste includes as a minimum, the first and second particle populations discussed above. However there is in principle no reason why more than two particle size populations should not be present in the paste. For example there might be a first population of binder particles, a second population of binder or non-binder particles capable of packing the interstices between the first particles, and a third binder or non-binder particle population capable of packing the interstices between the combined first and second populations. A population of small, for example-up to 1 mm, of aggregate particles for example of silica or carborundum sand may be included in the paste, and/or a population of small fibres, for example of polymer such as polyethylene or polypropylene, or of glass or steel. All populations of particles and fibres present in the composition should preferably be well mixed and as near homogeneously dispersed as possible. The paste may also include biologically active agents, such as herbicidal, antifungal or antimicrobial agents to provide additional protection against the growth of moss, algae, lichen or mould.

The surface of the substrate to which the paste layer is applied is advantageously rough and porous, to encourage good adhesion to the paste layer. If the article or shaped mass is a concrete tile manufactured via a normal tile production sequence as described above, even after the slipper or glitter step the surface is normally sufficiently rough and porous to permit good paste layer adhesion, but that step may sometimes be omitted. Alternatively, the surface of the article or shaped mass may be roughened or primed with an adhesion aid prior to spreading the paste layer.

The Membrane and Plate

Membranes suitable for covering the surface of the paste layer should be flexible, so that they may be laid in intimate contact with and conforming to the contours of the area of the paste layer on the surface of the article which it is to cover. For the same reason, suitable plates should, have a smooth contoured under-surface. Air bubbles between the membrane or plate and the paste layer are preferably avoided, as are wrinkles in the membrane. The membrane or plate may be perforated or unperforated. Generally, membranes should be laid as a skin on the area of paste layer to be covered. Thus, membranes may be rolled onto a pre-spread paste layer, or portion(s) of paste may be deposited on the article spread by the act of rolling a membrane, or pressing a plate, into contact with the paste portions, thus spreading the paste layer on the article.

The under-surface of the membrane or plate in contact with the surface of the paste layer should be smooth, since the surface smoothness of the article after the method of the invention is in part a function of intimate contact with the membrane or plate under-surface. The optional vibration step causes the particles in the surface of the paste layer to be agitated into increasingly intimate contact with the membrane or plate under-surface, so that the surface characteristics of the article mirror those of the membrane undersurface to a large extent.

Preferably, the membrane or plate has low adhesion affinity for the paste layer, so that it may eventually be peeled or otherwise separated from that layer, which has preferably been hardened or partially hardened, without significant damage to the paste layer surface. Flexible, smooth membranes for use in the invention include plastics films, for example of polyethylene or polypropylene, but is some cases paper based sheets, optionally with polymer coatings, or metal foils may be suitable. Plates for use in the invention include plastics plates, for example of acrylic resin materials, and metal plates such as steel plate. The undersurface of the plate may be polished, or coated or plated with a bright metal, for example by vapour deposition or electrodeposition, to improve surface smoothness. The hardening process for the paste layer, and the article itself if not pre-hardened, may involve heating in an oven, and in such cases it will of course be desirable to choose a membrane or plate material which is compatible with the hardening temperature and duration, or to separate the membrane from the paste layer prior to exposure to the hardening temperature.

In some cases it may be desirable to carry out the method of the invention by first laying a flexible membrane over the paste layer, then superimposing a plate on the membrane. For example, when the optional vibration step is employed, it may be preferable to use either a plate alone or a plate superimposed on a membrane, since transmission of vibration through a plate via a vibrating head may be less likely to wrinkle the membrane.

In the method of the invention, a relief-pattern may be formed on the smooth under-surface of the membrane or plate, such that when the membrane or plate covers and contacts the paste layer the relief pattern impresses the surface paste layer. Where a flexible membrane covers the paste layer the relief-pattern may be impressed on the paste layer by a tool, for example a roller, pressed into contact with the upper surface of the membrane. Where a flexible membrane covers the paste layer and a plate is superimposed thereon, and the under-surface of the plate has a relief-pattern formed thereon, a corresponding relief pattern is impressed on the paste layer through the membrane by pressing the plate into contact with the upper surface of the flexible membrane. Similar results are achieved by interposing a relief pattern between the membrane and the superimposed plate, in which case of course the under-surface of the plate need not be figured.

For tile production, the surface to be treated in accordance with the invention will normally be the exposed upper surface, i.e. the surface which is visible when the tile is in use, although the invention can also be applied on both surfaces of the tile if required. For example where the normal tile production process described above is employed, the base of the moulds on the conveyor belt may serve as a plate or may be lined with the desired membrane, and paste may be deposited on the mould or on the membrane in the mould. As the ribbon is accommodated in the mould, the paste in the mould may be spread as a layer on the underside of the tile. For roofing tiles, the bottom edge of the tile (the “nose”) is also visible, and the surface of that edge may benefit from treatment. Hence, plates may be shaped, and membranes may be cut to a size, such that they least cover the upper tile surface and extend over the nose. A single membrane piece might cover the upper tile surface and nose, or one membrane piece might cover the upper tile surface, and another the nose.

In a production process, the individual membrane or plate covers may be dispensed onto the tiles from a stockpile. A membrane may also be dispensed from continuous stock stored on a roller, rolled onto the tiles, tile ribbon or cut tile forms, then cut to the required individual tile size when in position covering the ribbon (for example as the ribbon is cut into individual tile forms) or covering the individual tiles or tile forms.

Optional Surface Vibration Through the Membrane and/or Plate

When the method of the invention is implemented using a smooth membrane in intimate contact with the paste layer, the paste layer may be vibrated through the membrane by pressing into intimate contact an area of the membrane-covered area of the paste layer and a membrane-contact surface of a vibratable plate element contoured to match that of the membrane-covered area of the paste layer, and causing the vibratable plate element to vibrate while maintaining pressure contact between it and the membrane-covered area of the paste layer, such that vibration is transmitted from the vibratable plate element, through the membrane, to the surface of the substrate. Thereafter contact between the vibratable plate element and the membrane-covered surface of the paste layer is broken and the membrane is removed or, preferably, the paste layer is at least partially hardened with the membrane in place.

When the method of the invention is implemented using a smooth plate in intimate contact with the paste layer, the paste layer may be vibrated through the plate by pressing a vibrating head element into intimate contact with an area of the plate-covered area of the paste layer, and causing the head element to vibrate while maintaining pressure contact between it and the plate-covered area of paste layer, such that vibration is transmitted through the plate element to the paste layer. Thereafter contact between the head element and the plate-covered surface of the article is broken and the plate is separated from the paste layer or, preferably, the paste layer is at least partially hardened with the plate in place.

The vibratable plate element in contact with the membrane, or the smooth plate in contact with the paste layer, is conveniently of plastics material or sheet metal, contoured to match the contours of the area of paste layer which it covers. Such a plastics or sheet metal plate may be vibrated by contacting a vibrating head element with the side of the plate opposite to the paste layer, and if necessary causing relative movement between the head element and the contacted plate, such that the vibrating head element traverses a desired area of that side. Since most tiles are rectangular in configuration, the vibratable plate element, or of course the smooth plate, may also be rectangular with uniform transverse cross sectional profile, matching the contours of the upper tile surface In such cases, the vibrating head element may be contoured to match that profile, and the head may be caused to move longitudinally relative to the plate.

The axis or main axis of vibration of the plate may be perpendicular to the plane of the plate, but the vibration may also have components in other directions. Surface improvements are often obtained when vibration of a frequency of at least 10 Hz is transmitted from the plate element to the surface of the article. However, the frequency, amplitude and duration of the vibration may vary within wide ranges. Optimum parameters will be selected according to such factors as the composition of the paste layer being treated; the depth to which it is desired to influence the paste layer; the degree of surface glaze required; and whether the production process for the article is a batch process or a continuous process. Good surface effects are often obtained when the plate is vibrated at ultrasonic frequencies, for example in the range 15 kHz to 50 kHz, or 15 kHz to 30 kHz, or using a combination of first mechanical vibration for example in the range of 25 to 800 Hz and then vibration at ultrasonic frequency. The amplitude of vibration of the vibratable plate may be in the range 1 mm to 3□m. In one embodiment of the invention, the vibratable plate is alternately vibrated at two or more different frequencies and/or amplitudes.

As foreshadowed above, the frequency and amplitude of the vibration of the vibratable plate and the duration of the vibration may be selected to increase the surface density of the paste layer, relative to its density prior to vibration, to a depth of at least 10%, 25%, 50% or all of its thickness.

In the case of the continuous production of concrete tiles referred to above, i.e. by extrusion as a ribbon onto moulds carried on a conveyor belt, followed by cutting between moulds into individual tile format, the speed of production is conventionally relatively high, for example of the order of 100-150 tiles per minute. While continuous membrane sheet may be dispensed from a roller to cover the paste layer on the cut or uncut tile ribbon at those speeds, the speed of a single cycle of individual membrane or plate application and/or optional vibrational surface treatment may be too slow to be performed on each tile sequentially on a single conveyor belt. Hence, in one embodiment of the invention, the conveyor means divides into a plurality of tracks after the ribbon is cut into individual tiles. Tiles queued on the conveyer are successively transported onto separate tracks for the application of individual membrane-or plate covers and/or optional vibrational treatment on each tile at individual stations associated with each track. The tracks recombine thereafter to reconstitute the queue of now membrane- or plate covered tiles for transport to hardening.

Hardening

After membrane and/or plate covering, and optional vibration treatment, in accordance with the invention, the membrane or plate is removed or, preferably, the substrate or article is at least partially hardened with the membrane or plate still in place. The latter is preferable for two main reasons. Firstly, attempting to peel the membrane or slide or otherwise separate the plate from the surface of the substrate or article before any significant hardening of the paste layer may disturb the smoothness of its still unhardened surface to some extent (though this may be minimised by careful removal of the membrane or plate, and by choice of membrane or plate and paste layer surface characteristics which minimise adhesion of the membrane to the paste layer). Surface smoothness damage is increasingly less likely as the paste layer hardens. Secondly, the membrane or plate protects the treated surface from damage during or after handling. In fact, it may be desirable in the case of tile manufacture to keep the membrane (less desirably the plate) in place until the point of end use, for this very reason. Curing for 8 hours or more with the membrane or plate in place will often be desirable to encourage good surface smoothness.

Other Aspects

In addition to the surface smoothness produced by the method of the invention, partial or substantially complete hardening of the paste layer with the membrane or plate in place is presently believed to promote homogeneity of the hardened layer and thus to improve weathering and suppression of efflorescence. In that connection, in the case of Portland cement based materials such as concrete tiles, the reaction of the cement with water (hydration) yields many different reactions products. Of these, about 25% by mass is calcium hydroxide, some of which may be transported to the exposed surface of the cement-based material and, in combination with carbon dioxide from the air, tend to form insoluble calcium carbonate, which can be seen as white blotches and cause discolorations on the surface. The phenomenon is called efflorescence, and occurs when calcium hydroxide dissolves into the pore liquid (free water) of the concrete, migrates to the surface, is distributed on to the surface via surface moisture/water film, and combines with carbon dioxide.

However, the formation of calcium carbonate can also be used as an advantage, if it can be encouraged to occur under the surface and thereby block transportation of calcium hydroxide to the surface, reducing efflorescence. Furthermore, if the reaction between cement and water could be encouraged to proceed until complete hydration during the hardening process, or at least reach a stage where the capillary system of the hardening material is disconnected, thereby preventing calcium hydroxide being transported from the interior to the surface, no further calcium hydroxide (and thus efflorescence) would be formed when the product leaves the factory. As an additional (often preferred) precaution, calcium hydroxide at or very close to the exposed surface may be removed or carbonated.

An interesting benefit of the present invention is improvement of the hardening conditions in accordance with the above principles. The membrane (or plate) protects the surface against drying, thus securing a higher degree of sub-surface hydration and more homogeneity throughout the product. For example, concrete roof tiles are traditionally hardened in a chamber having a relatively humidity of about 80-95%. Under such conditions there is a risk of drying of the surface layer, thus the potential of forming new calcium hydroxide in the top layer of the product is high, due to insufficient hydration. The use of a membrane (or plate) and paste layer in accordance with the invention encourages hydration in the substrate and paste layer, reducing risk of efflorescence.

Some implementations of the method of the invention may cause a very thin porous layer to be formed at the surface of the paste layer. Since it is so thin, the formation of that layer is not in contradiction of one of the objects of the invention, which is to reduce the overall porosity of the surface. In any event, such a layer is easily removed, leaving the intended smooth, reduced porosity surface, for example via an acid wash. Such a wash also removes any small amounts of calcium hydroxide and/or calcium carbonate present on the exposed surface of concrete products despite the benefits of the method of the invention, and is therefore additionally beneficial in reducing efflorescence on concrete products still further. As a further refinement, concrete products prepared by the method of the invention can be treated in a carbon dioxide enriched atmosphere (5%) for about 15-60 minutes to reduce still further the risk of efflorescence.

Special Effects

When the optional vibrational step is employed in the process of the invention, a dry, particle-containing composition may be applied to the surface of the paste layer prior to its being covered by the membrane and/or plate. The vibrational treatment then causes the particles of that composition to become embedded in the vibrated surface of the paste layer. Particles such as colour pigment, silicate granules, metal, or polymer particles may be incorporated in this way.

The principles of the invention will now be further discussed by reference to the following Drawings (which are not to scale), wherein

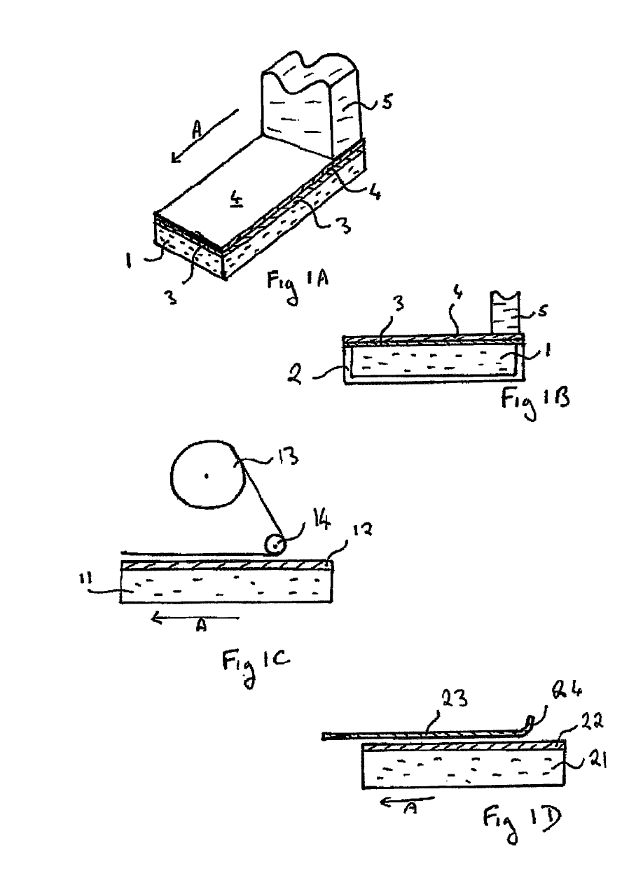

FIG. 1A is a simplified perspective view of an assembly consisting of a flat tile with a paste layer spread on its upper surface, a flexible membrane or plate covering the entire area of the paste layer.

FIG. 1B is a schematic longitudinal cross-sectional view of the assembly of FIG. 1A.

FIG. 1C shows in schematic cross-section how a membrane may be laid to cover the spread paste layer to produce the assembly of FIG. 1A.

FIG. 1D shows in schematic cross-section how a plate may be laid to cover the spread paste layer to produce the assembly of FIG. 1A.

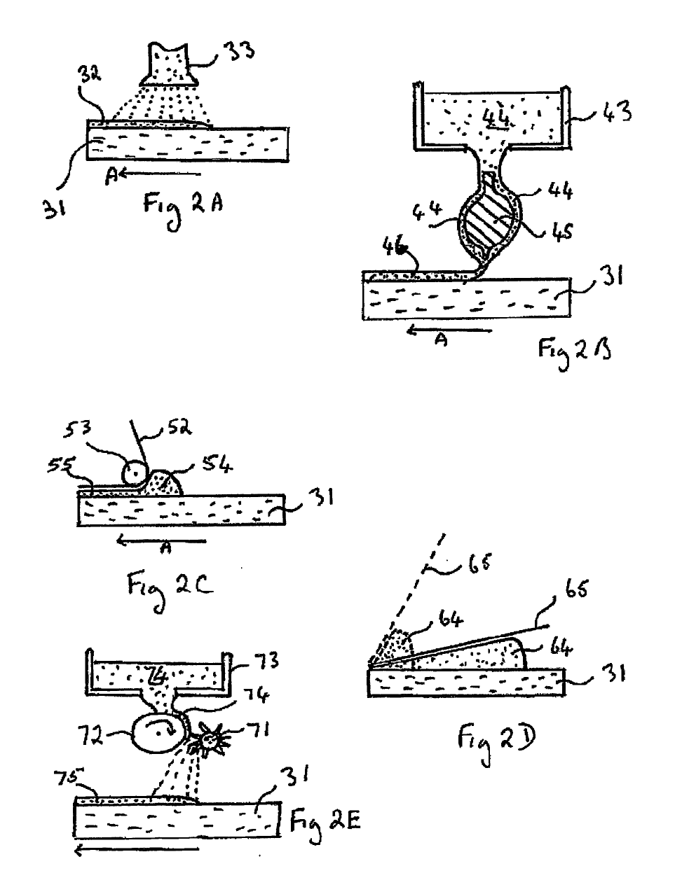

FIG. 2A shows in schematic cross-section how a paste layer may be spread on a tile or tile ribbon by spraying.

FIG. 2B shows in schematic cross-section how a paste layer may be spread on a tile or tile ribbon by curtain deposition from a flow guide tool.

FIG. 2C shows in schematic cross-section how a paste layer may be spread on a tile by squeezing a portion of paste deposited on the tile between the tile and a membrane as the latter is rolled onto the paste portion.

FIG. 2D shows in schematic cross-section how a paste layer may be spread on a tile by squeezing a portion of paste deposited on the tile between the tile and a plate as the latter is pressed onto the paste portion.

FIG. 2E shows in schematic cross-section how a paste layer may be spread on a tile by spattering from a roller.

Referring to FIGS. 1A and 1B, numeral 1 indicates (a) a plain, generally flat clay or cementitious roofing tile, or (b) an unhardened water-containing clay or cementitious mass moulded in mould 2 (shown in FIG. 1B, but omitted for clarity in FIG. 1A) into the form of a plain, generally flat roofing tile, or (c) a section of a continuous ribbon of unhardened water-containing clay or cementitious mass from which tile forms (b) may be cut. A paste layer 3 is spread on the upper surface of the tile, tile form or ribbon. Numeral 4 indicates a flexible membrane, for example of polyethylene or polypropylene or paper-based material, or a plate of, for example, acrylic plastics or steel, covering the upper surface of the paste layer and lying in intimate contact with that surface. The membrane or plate has a smooth under-surface in contact with the paste layer, and is sized to cover the area of the paste layer, possibly with marginal overhangs.

An optional resiliently mounted vibrator head 5 of the same width as the tile, tile form or ribbon 1, vibrating, for example, at about 20 kHz mainly in the plane perpendicular to the plane of the paste layer, may be pressed into contact with the upper surface of the membrane or plate. In a variation, a membrane may be in contact with the paste layer, a plate may be superimposed on the membrane, and the vibrator head may contact the plate. The vibrator head is movable, while still in pressure contact with the membrane or plate, in the direction indicated by arrow A, to traverse the entire length of the tile, tile form or ribbon. The vibrating head traverses the length (and thus the area) of the membrane- or plate-covered paste layer. That process may be optionally repeated as many times as desired, or multiple vibrator heads may be arranged to traverse the membrane- or plate-covered paste layer sequentially.

Multiple vibrator heads or multiple vibrator head passage passage, allows the paste layer to be vibrated at different frequencies. After vibration, the head is lifted out of contact with the membrane or plate.

The membrane- and/or plate-covered tile or tile form (after optional vibration treatment) is transported for the paste layer (and the unhardened tile form if still unhardened at this stage) to be at least partially hardened at ambient temperature, or in an oven. The membrane or plate may be removed from the paste layer after partial or substantially complete hardening, or later.

In FIG. 1C, a hardened or unhardened tile 11 having a paste layer 12 spread over its upper surface is being conveyed in the direction of arrow A. A roll of membrane feedstock 13 having a smooth under-surface is positioned to dispense a continuous sheet of membrane material onto and into intimate contact with the surface of the paste layer, via a membrane application roller 14 which is in slight pressure contact with the paste layer (although for clarity, the roller and membrane are drawn out of contact with the paste layer). When the passage of the tile 11 past the application roller 14 has covered the paste layer with membrane, a knife tool (not show) cuts the membrane across the tile width to allow the membrane covered tile to pass downstream for the paste layer hardening stage.

In FIG. 1D, a hardened or unhardened tile 21 having a paste layer 22 spread over its upper surface is being conveyed in the direction of arrow A. As the tile is conveyed the paste layer slides under and into intimate contact with the smooth under-surface of a flat steel or acrylic plate 23 (although again for clarity, the plate is drawn out of contact with the paste layer). Smooth sliding of the tile under the plate is assisted by the slightly curved configuration of the front end 24 of the plate. The plate is maintained in a fixed position by a plate holding and release mechanism (not shown). When the passage of the tile 21 under the plate has positioned the plate so that it covers the paste layer, the plate is released by the plate holding and release mechanism and the plate-covered tile passes downstream for the paste layer hardening stage.

In FIG. 2A, numeral 31 indicates (a) a hardened tile, or (b) an unhardened water-containing clay or cementitious mass carried in a mould or pallet (not shown) in tile format, or (c) a section of a continuous ribbon of unhardened water-containing clay or cementitious mass from which tile forms (b) may be cut. A layer 32 of paste of sprayable consistency is sprayed from spray head 33 onto the upper surface of the tile, or unhardened tile form or ribbon. The paste layer is built up by passage of the tile, tile form or ribbon past the spray head in the direction of arrow A. More than one spray head might be employed.

In FIG. 2B numeral 31 has the same significance as in FIG. 2A. Paste 44 of flowable consistency flows from storage hopper 43 over the surface of a suitably shaped flow guide tool 45, and is deposited as a curtain to form a layer 46 on the upper surface of the tile, or unhardened tile form or ribbon as it passes under the flow guide in the direction of arrow A.

In FIG. 2C numeral 31 has the same significance as in FIG. 2A. As in FIG. 1C, a membrane feedstock 52 having a smooth under-surface is dispensed via a membrane application roller 53. A portion of paste 54 was previously deposited as a strip across the width of the tile, tile form or ribbon 31 at its leading edge as it moves in direction of arrow A, or in the case of a ribbon at spaced intervals across its width. As the paste portion encounters the membrane application roller, it is squeezed between the membrane being unwound from the roller and the tile, tile form or ribbon, causing it to be spread as a paste layer 55, covered by the membrane.

In FIG. 2D numeral 31 has the same significance as in FIG. 2A. As described in relation to FIG. 2C, a portion of paste 64 was previously deposited as a strip or strips across the width of the tile, tile form or ribbon 31. A plate 65 is pivotally positioned at an acute angle to the plane of the tile, tile form or ribbon. Initially the plate 65 and paste portion 64 are in a positional relationship similar to those shown by broken lines. The angle between the plate and the tile, tile form or ribbon is then reduced by rotating the plate about its lower edge, through a relative position similar to that shown by the continuous lines depicting plate 65 and paste portion 64, until the plate lies parallel to the surface of the tile, tile form or ribbon, spaced therefrom by a thickness corresponding to the desired depth of paste layer. This has the effect of squeezing the paste portion between the plate and the tile, tile form or ribbon, causing it to be spread as a paste layer, covered by the plate.

In FIG. 2E numeral 31 has the same significance as in FIG. 2A. Paste 74 of flowable consistency flows from storage hopper 73 onto a roller 72 rotating clockwise. A stiff brush roller 71 rotates counter clockwise and is positioned longitudinally adjacent the roller 72. as the paste carried on roller 72 encounters the rotating brush 71, the brush sweeps the paste from the roller and throws it as a shower onto the surface of the tile, tile form or ribbon as it is coveyed in the direction of arrow A, thereby building up the desired paste layer 75.

The above discussion of FIGS. 1A-1D and FIGS. 2A-2E have been in relation to plain flat tiles of substantially rectangular cross section. For many roofing applications, the tiles have a contoured cross section, for example a substantially S-shaped contour. The principles discussed in relation to flat tiles are equally applicable to contoured tiles, with appropriate contouring of any membrane application rollers, paste flow guide tools, paste layer cover plates, vibrator heads and the like. Similarly, the principles discussed are generally applicable to other clay, cementitious, or ceramic articles, with appropriate matching of size and contour of the elements of the process to the size and shape of the article.

Furthermore, although the method of the invention has been illustrated by reference to the surface treatment of a tile, the same principles apply to the treatment of other substrates. Where the substrate is normally vertically orientated, as in the case of a wall, door or column, or a section thereof, the Theological properties of the paste will be selected to minimise slumping from the vertical surface of the substrate. Where the substrate is normally horizontally orientated with an exposed underside requiring treatment, such as a ceiling or section thereof, again the rheological properties of the paste will be chosen to avoid dripping or separation from the horizontal substrate surface. Where the substrate is normally horizontal with an exposed upper surface requiring treatment the Theological properties of the paste will be chosen to avoid run-off from or pooling on the substrate surface.

1. A method for the surface treatment of a substrate comprising
(i) spreading a layer of hardenable paste over a surface area of the substrate to be treated, the paste comprising at least first and second populations of particles co-dispersed in a water-containing phase, the second population being sufficiently small to pack the interstices between particles of the first population with which it is co-dispersed, at least one of the first and second populations being of reactive binder particles,
(ii) covering a surface area of the paste layer with (a) a flexible membrane or (b) a plate or (c) first a flexible membrane then superimposed thereon a plate, the plate or membrane having an upper-surface and a smooth under-surface, such that in cases (a) and (c) the smooth membrane under-surface, and in case (b) the smooth plate under-surface, is in intimate contact with and conforms to the contours of that surface area of the paste layer, thereby providing a membrane-covered or plate-covered area of the paste layer,
(iii) optionally vibrating the membrane-covered or plate-covered area of the paste layer, such that vibration is transmitted through the membrane or plate, to the paste layer, and
(iv) either removing the membrane, plate or plate and membrane then hardening the paste layer on the substrate, or at least partially hardening the paste layer on the substrate with the membrane, plate or plate and membrane in place.

2. A method as claimed in claim 1 wherein the substrate is a wall, floor, ceiling, column, door, or a section of any of the foregoing.

3. A method as claimed in claim 1 wherein the substrate is a hardened or partially hardened clay, ceramic or cementitious article, or a hardenable, water-containing clay, ceramic or cementitious mass shaped in the form of the article.

4. A method as claimed in claim 3 wherein the article is, or the mass is shaped in the form of, a roofing tile, a wall tile, a floor tile, a roofing panel, a pipe, a work-top, a paving block or a wall cladding panel.

5. A method as claimed in claim 1 wherein the substrate is orientated generally horizontally during step(i) and/or (ii).

6. A method as claimed in claim 1 wherein the substrate is orientated generally vertically during step (i) and/or (ii).

7. A method as claimed in claim 1 wherein in step (i) one or more portions of paste is/are positioned on the substrate and spread as the desired layer by causing the membrane or plate to be pressed into contact with the portion(s) during the covering step (ii), thereby causing the portion (s) to spread as the desired paste layer between the under-surface of the membrane or plate and the article or shaped mass.

8. A method as claimed in claim 1 wherein the membrane or plate is pressed into intimate contact with the paste layer by rolling pressure applied to the membrane or plate or by reduced atmospheric pressure between the membrane or plate and the paste layer.

9. A method as claimed in claim 1 wherein the surface of the substrate is treated prior to spreading the paste layer, to improve binding between it and the paste layer.

10. A method as claimed in claim 1 wherein the flexible membrane is of plastics or paper-based material or the plate is of plastics material or metal.

11. A method as claimed in claim 1 wherein the first particle population of the paste has a weight average particle size in the range 1 μm to 500 μm and the second particle population has a number average particle size from 0.00 μm to 40 μm.

12. A method as claimed in claim 6 wherein the first particle population is of reactive binder particles, e. g. cement, and/or fly ash and/or_blastfurnace slag particles and the second particle population is of binder particles or of non-binder particles.

13. A process as claimed in claim claim 1 wherein in the paste additionally comprises a population of aggregate particles having a weight average particle size in the range 50 μm to 500 μm, and/or a population of micro-aggregate particles having a weight average particle size in the range 0.01 μm to 50 μm and/or a population of micro fibers having a mean length in the range 100 μm to 5 mm.

14. A method as claimed in claim 1 wherein the paste is degassed or mixed to minimize entrained gas bubbles prior to being spread on the article or shaped mass.

15. A method as claimed in claim 1 wherein the paste layer on the substrate is hardened or partially hardened with the membrane, plate or plate and membrane in place, and then the membrane, plate or plate and membrane is separated from the hardened or partially hardened paste layer.

16. A method as claimed in claim 1 wherein in step (ii) a membrane is contacted with the paste layer, and a vibrational step (iii) is implemented by vibrating the paste layer through the membrane by pressing into intimate contact an area of the membrane-covered area of the paste layer and a membrane-contact surface of a vibratable plate element contoured to match that of the membrane-covered area of the paste layer, and causing the vibratable plate element to vibrate while maintaining pressure contact between it and the membrane-covered area of the paste layer, such that vibration is transmitted from the vibratable plate element, through the membrane, to the surface of the paste layer.

17. A method as claimed in claim 1 wherein in step (ii) a plate is contacted with the paste layer, or a membrane is contacted with the paste layer and a plate is superimposed thereon, and a vibrational step (iii) is implemented by pressing a vibrating head element into intimate contact with an area of the plate-covered area of the paste layer, and causing the head element to vibrate while maintaining pressure contact between it and the plate-covered area of paste layer, such that vibration is transmitted through the plate element to the paste layer.

18. A method as claimed in claim 16 wherein the plate is vibrated by contacting a vibrating head element with the side of the plate opposite the paste layer, and causing relative movement between the head element and the contacted plate and membrane-covered area of the paste layer, such that the vibrating head element traverses a desired area of that side.

19. A method as claimed in claim 18 wherein the vibratable plate element is rectangular with uniform transverse cross sectional profile, the vibrating head element is contoured to match that profile, and the head is caused to move longitudinally relative to the plate.

20. A method as claimed in claim 16 wherein the axis or main axis of vibration of the surface of the paste layer of the substrate is generally perpendicular to that surface.

21. A method as claimed in claim 16 wherein vibration of a frequency of at least 10 Hz is transmitted to the surface of the substrate.

22. A process as claimed in claim 16 wherein the frequency and amplitude of the vibration and the duration of the vibration are selected to increase the surface density of paste layer, relative to its density prior to vibration, to a depth of at least 10% of its thickness.

23. A process as claimed in claim 16 wherein the frequency and amplitude of the vibration and the duration of the vibration are selected to increase the surface density of the paste layer, relative to its density prior to vibration, to a depth of at least 25% of its thickness.

24. A process as claimed in claim 16 wherein the frequency and amplitude of the vibration and the duration of the vibration are selected to increase the surface density of the paste layer, relative to its density prior to vibration, to a depth of at least 50% of its thickness.

25. A process as claimed in claim 16 wherein the frequency and amplitude of the vibration and the duration of the vibration are selected to increase the density of the paste layer throughout its entire thickness.

26. A process as claimed in claim 16 wherein the vibration transmitted through the plate or plate and/or membrane has a frequency in the range 15 kHz to 50 kHz.

27. A process as claimed in claim 16 wherein the vibration transmitted through the plate or plate and/or membrane has a frequency in the range 15 kHz to 30 kHz.

28. A process as claimed in claim 16 wherein the vibration transmitted through the plate or plate and/or membrane has an amplitude in the range from 1 μm to 3 pm.

29. A process as claimed in claim 16 wherein the vibration transmitted through the plate or plate and/or membrane varies in frequency and/or amplitude.

30. A method as claimed in claim 16 wherein a dry, particle containing composition is applied to the surface of the paste layer prior to its being covered by the membrane.

31. A method as claimed in claim 30 wherein the particles in the particle containing composition are color pigment, silicate granules, metal, or polymer particles.

32. A method as claimed in claim 1 wherein a relief pattern is formed on the paste layer contact surface of the membrane or plate or interposed between the plate and a membrane-covered area of the article, such that when the plate is pressed into contact with the membrane-covered area of the article and/or vibrated the relief pattern impresses the surface of paste layer.

33. A method as claimed in claim 1 wherein a membrane is in contact with the paste layer and a relief-pattern is impressed into the surface of the paste layer by a tool pressing the upper surface of the membrane when in contact with the paste layer.

34. A process as claimed in claim 1 wherein the substrate is cementitious, containing cement particles and microsilica particles as reactive binder particles.

35. A process as claimed in claim 34 wherein the substrate contains sand.

36. A process as claimed in claim 1 wherein the paste layer comprises cement and after step (iv) the surface of the paste layer is acid-washed and/or exposed to a carbon dioxide-rich atmosphere.

37. A method as claimed in claim 1 for production of cementitious tiles for roofing or wall cladding, wherein the substrate is an at least partially hardened tile or hardenable water-containing cementitious mass shaped in the form of a tile, formed by
(a) providing a moldable, eventually hardenable mass comprising at least water and reactive binder particles, the latter including at least cement particles,
(b) extruding the mass from an extrusion orifice onto conveyor means adapted to carry the extruded mass as a ribbon away from the extrusion orifice, the ribbon having a lower surface in direct or indirect contact with the conveyor means and an upper surface,
(c) cutting the pressed, ribbon across its width into individual tile format and
(d) optionally at least partially hardening the individual tiles, and wherein the paste layer is spread after steps (a) and (b) or after steps (a) to (c) or after steps (a) to (d).

38. A method as claimed in claim 37 wherein the conveyor means is provided with a plurality of longitudinally closely adjacent pallets or moulds of individual tile dimensions onto which the ribbon is extruded, and the ribbon is cut into individual tiles across its width between adjacent pallets of moulds.

39. A method as claimed in claim 38 wherein the base of a pallet or mould 8 on the conveyor belt has a smooth surface to function as a plate in step (ii) or is lined with a smooth surfaced membrane to function as a plate covered membrane in step (ii), paste is deposited on the said smooth base or membrane, and the ribbon is deposited or pressed onto said base or membrane whereby the paste is spread as a layer on the underside of the tile.

40. A method as claimed in claim 36 wherein, the conveyor means divides into a plurality of tracks after the ribbon is cut into individual tiles, tiles queued on the conveyer are successively transported onto separate tracks for the application of individual membrane or plate covers and/or optional vibrational treatment on each tile at individual stations associated with each track, and the tracks recombine thereafter to reconstitute the queue of tiles for transport to hardening.
